(19) United States
(12) Patent Application Publication
(10) Pub. No.: US 2025/0298389 A1
(43) Pub. Date: Sep. 25, 2025

(54) DRAFT ANGLE SCULPTING OF THREE-DIMENSIONAL MODELS OF PHYSICAL OBJECTS FOR CASTING AND MOLDING MANUFACTURING PROCESSES

(71) Applicant: Autodesk, Inc., San Francisco, CA (US)

(72) Inventors: Benjamin McKittrick Weiss, Tualatin, OR (US); Jesus Rodriguez, Farmington, MI (US); Jaesung Eom, Wexford, PA (US)

(21) Appl. No.: 19/037,029

(22) Filed: Jan. 24, 2025

Related U.S. Application Data
(60) Provisional application No. 63/569,672, filed on Mar. 25, 2024.

(51) Int. Cl. G05B 19/4097

(52) U.S. Cl. CPC G05B 19/4097; G05B 2219/35134

(57) ABSTRACT

Methods, systems, and apparatus, including medium-encoded computer program products, for computer aided design of physical structures using three-dimensional model synthesis processes. A method includes: obtaining a draft angle, an ejection direction, and a 3D shape for a casting or molding process; modifying data values in discrete elements (from which the 3D shape is determinable) to add material to the modelled object, including, for each of the discrete elements, changing a current value of the discrete element based on a comparison of the current value with an other value and a constant value, the other value being determined from one or more values found in one or more other discrete elements in the data structure located away from the discrete element along the ejection direction, and the constant value being determined for the draft angle; and providing the data structure with the modified data values for further processing.

### CROSS-REFERENCE TO RELATED APPLICATIONS

This application claims the benefit of priority of U.S. Patent Application No. 63/569,672, entitled “DRAFT ANGLE SCULPTING OF THREE-DIMENSIONAL MODELS OF PHYSICAL OBJECTS FOR CASTING AND MOLDING MANUFACTURING PROCESSES”, filed 25 Mar. 2024.

### BACKGROUND

### Technical Field

This specification relates to computer aided design of physical structures, which can be manufactured using casting or molding processes.

### Description of Related Art

In the design and manufacturing industry in which this innovation has its primary relevance, Computer Aided Design (CAD) software is used to generate three-dimensional (3D) representations of objects, while Computer Aided Manufacturing (CAM) software is used to prepare, evaluate, plan, and control the manufacture of those objects, e.g., using a 3D printer or other additive manufacturing techniques.

CAD software has been designed to perform automatic generation of 3D geometry of one or more parts in a design (known as “topology optimization”, “generative design”, or “generative modelling”, and more recently AI-enhanced shape synthesis tools). This automated generation of 3D geometry often works within a “design domain” specified by a user or the CAD software and generates geometry typically by optimizing design objectives and respecting design constraints, which can be defined by the user, the CAD software, or a third party. Design objectives can include minimizing waste material, minimizing the weight of the part, and minimizing the compliance, stress, or other intrinsic property of the part, and are used to drive the shape synthesis process towards better designs. Though not required, it is typical for a design objective to be rooted in a simulation of the design, e.g., linear static, fluid dynamic, electromagnetic, etc. Design constraints can include a variety of physical characteristics or behaviors that must be met in any generated design (requirements either on individual parts or on the entire assembly are also admissible); examples include maximum mass, maximum deflection under load, maximum stress, etc. Geometric constraints may also be provided, for example to ensure the generated shape has no tiny features or is more easily built using a particular manufacturing process.

Further, the geometric inputs to such a 3D geometry generation tool can include one or more user—or CAD system—provided “preserves” which are surfaces or bodies which should always be present in the design, and which represent interfaces to other parts of the systems or locations on which boundary conditions should be applied (for example mechanical loads and constraints). Other regions in which geometry should or should not be generated can also be provided in a similar manner (referred to as “obstacle bodies”). Often, the shape synthesis process takes place using a different representation of geometry than that employed by the CAD system. For example, a CAD system might use a boundary representation (“B-Rep”) while the geometry generation engine might employ a level set function embedded in a voxel or tetrahedral mesh.

“Casting” and “molding” cover a range of manufacturing processes that create parts by solidifying molten (or quasi-molten) feedstock inside the cavity of a mold (often composed of two or more pieces held together). Once the feedstock has solidified, the mold is removed to reveal the final part. Casting processes support a variety of feedstock materials, including metals, plastics, and ceramics, and different processes leverage different configurations of the mold and feedstock material.

In some casting and molding processes (such as injection molding), the mold is arranged into two halves which meet at a “parting surface”, which can be a plane or non-planar surface. The mold is removed from the manufactured part at the end of the process by drawing the two mold halves away from each other along a specified “ejection direction” or “draw direction”. It is a design requirement for parts manufactured using processes like this that the two halves of the mold must be able to be removed without interfering with the final part. This constraint is satisfied by ensuring no “overhanging” or “enclosed” regions of the part would cause the mold to interlock with the final part, and that vertical surfaces are drafted (slanted) such that they allow the mold to be cleanly removed without introducing friction.

In other casting and molding processes (such as sand casting), the mold is created from a low cost material such as sand and is destroyed at the end of the process. The creation of the mold is performed using a casting-like preprocess in which a designed part is split along the parting surface and used to form sand or another mold material into two half-molds which are fused together to form the final mold. In this case, the design constraint comes from the need to remove the designed part from the mold halves during mold construction and must meet the same overhang and draft constraints described above.

More generally, additive manufacturing, also known as solid free form fabrication or 3D printing, refers to any manufacturing process where 3D objects are built up from raw material (generally powders, liquids, suspensions, or molten solids) in a series of layers or cross-sections. Examples of additive manufacturing include Fused Filament Fabrication (FFF) and Selective Laser Sintering (SLS). Casting and forging (both hot and cold) and molding can be grouped with additive manufacturing processes in that the manufactured objects are built in 3D by the addition of raw materials, rather than by removal (or subtraction) of material from a starting “blank” or workpiece, as in Computer Numerical Control (CNC) milling.

### SUMMARY

This specification describes technologies relating to computer aided design of physical structures, which can be manufactured using casting or molding processes.

The described systems and techniques allow automatic creation of components which can be manufactured using a casting or molding process that have overhang or draft requirements, thus reducing the complexity and costs of manufacturing parts that have been algorithmically designed (at least in part). A draft angle sculpting process can be run by the computer on a three-dimensional shape of a modelled object (e.g., during a shape synthesis process, such as inside an iterative loop of topology optimization) to ensure the design of the modelled object has no undercuts, which would trap the mold, or vertical walls, which cause undue friction with the mold, thus ensuring the mold can be removed from the manufactured part. Moreover, the draft angle sculpting process automatically removes overhangs at the same time. Thus, applying the draft angle sculpting process to the part can simultaneously ensure that (1) the draft angle of a target casting or molding manufacturing process is satisfied and (2) any undercut regions are removed.

The draft angle sculpting process can be implemented in the context of generative design, automated modeling, any of a variety of other shape synthesis algorithms, or as a tool to assist in the manual design of castable parts. In the context of shape synthesis, the draft angle sculpting process can be understood as a mold removability constraint implemented as a geometry filter. More generally, the draft angle sculpting process can be referred to as a mold removability filter for geometry of a three-dimensional model of a physical object.

Various embodiments of the subject matter described in this specification can be implemented to realize one or more of the following advantages. Overall part quality can be improved during generative design as compared to traditional manufacturing constraints for “die casting” design. Undesirable attempts to force preserve bodies to be manufacturable can be avoided. An explicit parting surface can be provided, which facilitates actually manufacturing resulting designs. The draft angle sculpting process (e.g., when used to constrain an optimizer in a shape and/or topology optimization) has improved robustness, which makes it less likely to fail for a given input, and has general applicability, which enables the algorithm to work in various workflows, such as in an analysis tool to aid in locating regions of a design which are not castable. Moreover, the algorithm can readily handle one, two, or more mold parts with arbitrary ejection direction orientations, thus facilitating automated design of three-dimensional structures to be manufactured using casting or molding process.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of a system usable to perform draft angle sculpting to produce physical structures with designs that are tailored to facilitate manufacturing using casting or molding manufacturing processes.

FIG. 2A shows an example of an input shape with an interior void and an overhang in relation to a parting surface.

FIG. 2B shows the result of removing the interior void and the overhang from the input shape of FIG. 2A.

FIG. 3A shows another example of an input shape and also its corrected shape after applying a mold removability filter.

FIG. 3B shows neighbor sampling for the mold removability filter.

FIG. 3C shows a schematic representation for a signed distance field update rule used to implement the mold removability filter.

FIG. 4A shows a discretized design domain with a parting plane.

FIG. 4B shows a top half pass of the discretized design domain from FIG. 4A with the mold removability filter.

FIG. 4C shows a bottom half pass of the discretized design domain from FIG. 4A with the mold removability filter.

FIGS. 5A-5C show an example of the need for wide band signed distance field data in some implementations.

FIGS. 6A-6C show undercuts resulting from smoothing the output of the mold removability filter and how to prevent those undercuts.

FIG. 7 shows the use of overshoot to prevent undercuts near the parting surface using the example of input from FIG. 5A.

FIG. 8 shows that bounding box expansion depends on the maximum height of the part.

FIGS. 9A-9D show examples of draft options for preserve bodies.

FIG. 10 shows an example of skin creation.

FIG. 11 shows how potential issues arise with a partial-draft algorithm.

FIG. 12 shows an example of a process employing draft angle sculpting, such as during shape synthesis, to produce physical structures with designs that are tailored to facilitate manufacturing using casting or molding processes.

FIG. 13A shows an example of applying the mold removability filter for a design using a primary ejection direction as well as an orthogonal core.

FIG. 13B shows a region of interest for a core.

FIG. 14 shows a region of interest applied to a casting constraint with one core.

FIG. 15 is a schematic diagram of a data processing system including a data processing apparatus, which can be programmed as a client or as a server.

FIG. 16 shows neighbor sampling and density field update rule used to implement the mold removability filter.

FIG. 17 shows sampling in a preserve density field to determine proximity to the preserve body.

Like reference numbers and designations in the various drawings indicate like elements.

### DETAILED DESCRIPTION

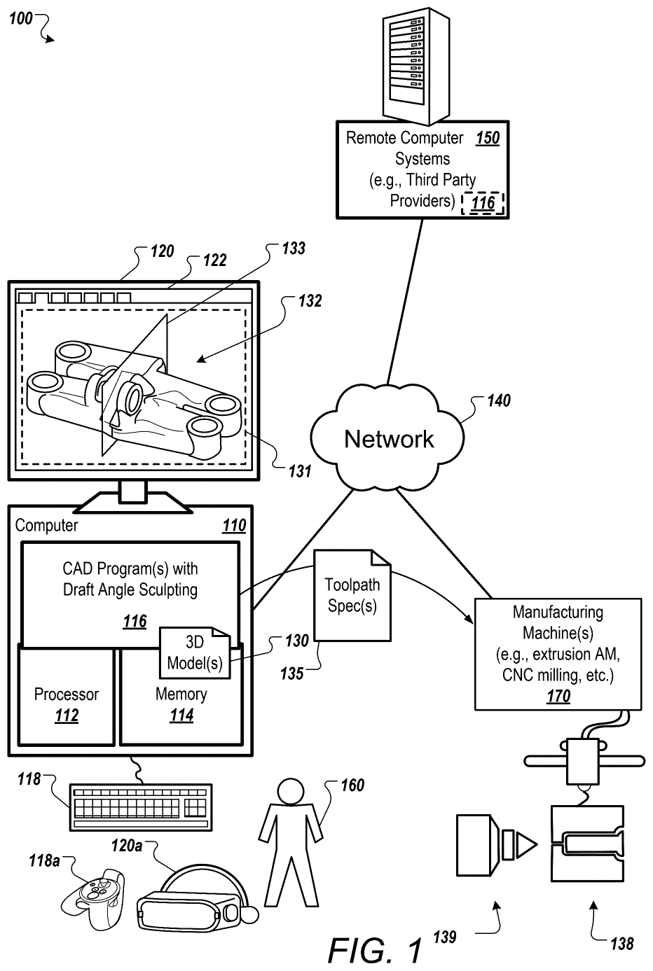

FIG. 1 shows an example of a system 100 usable to perform draft angle sculpting, such as can be performed during shape synthesis (e.g., during generative design using one or more boundary criteria) to produce physical structures that are tailored to facilitate manufacturing using casting or molding manufacturing processes. A computer 110 includes a processor 112 and a memory 114, and the computer 110 can be connected to a network 140, which can be a private network, a public network, a virtual private network, etc. The processor 112 can be one or more hardware processors, which can each include multiple processor cores. The memory 114 can include both volatile and non-volatile memory, such as Random Access Memory (RAM) and Flash RAM. The computer 110 can include various types of computer storage media and devices, which can include the memory 114, to store instructions of programs that run on the processor 112, including Computer Aided Design (CAD) program(s) 116, which implement three-dimensional (3D) modeling functions and includes a mold removability filter for geometry of a three-dimensional model of a physical object, which can be employed in one or more automated design processes, e.g., topology optimization using at least one level-set method, with or without numerical simulation.

As used in this detailed description, CAD refers to any suitable program used to design physical structures that meet design requirements, regardless of whether or not the program is capable of interfacing with and/or controlling manufacturing equipment. Thus, CAD program(s) 116 can include Computer Aided Engineering (CAE) program(s), Computer Aided Manufacturing (CAM) program(s), etc. The program(s) 116 can run locally on computer 110, remotely on a computer of one or more remote computer systems 150 (e.g., one or more third party providers' one or more server systems accessible by the computer 110 via the network 140) or both locally and remotely. Thus, CAD program(s) 116 can be two or more programs that operate cooperatively on two or more separate computer processors in that one or more programs operating locally at computer 110 can offload processing operations (e.g., generative design (or more generally, shape synthesis) and/or physical simulation operations) “to the cloud” by having one or more programs on one or more computers 150 perform the offloaded processing operations. In some implementations, all generative design (or more generally, shape synthesis) operations are run by one or more programs in the cloud and not in a shape representation modeler (e.g., B-Rep modeler) that runs on the local computer. Moreover, in some implementations, the generative design (or more generally, shape synthesis) program(s) can be run in the cloud from an Application Program Interface (API) that is called by a program, without user input through a graphical user interface.

The CAD program(s) 116 present a user interface (UI) 122 on a display device 120 of the computer 110, which can be operated using one or more input devices 118 of the computer 110 (e.g., keyboard and mouse). Note that while shown as separate devices in FIG. 1, the display device 120 and/or input devices 118 can also be integrated with each other and/or with the computer 110, such as in a tablet computer (e.g., a touch screen can be an input/output device 118, 120). Moreover, the computer 110 can include or be part of a virtual reality (VR) and/or augmented reality (AR) system. For example, the input/output devices 118, and 120 can include VR/AR input controllers, gloves, or other hand manipulating tools 118a, and/or a VR/AR headset 120a. In some instances, the input/output devices can include hand-tracking devices that are based on sensors that track movement and recreate interaction as if performed with a physical input device. In some implementations, VR and/or AR devices can be standalone devices that may not need to be connected to the computer 110. The VR and/or AR devices can be standalone devices that have processing capabilities and/or an integrated computer such as the computer 110, for example, with input/output hardware components such as controllers, sensors, detectors, etc.

In any case, a user 160 interacts with the CAD program(s) 116 to create and modify 3D model(s), which can be stored in 3D model document(s) 130. This can include initiating a shape synthesis process, which can take into account the planned manufacturing method by applying a draft angle sculpting during at least one or more intermediate iterations of a shape (and optionally topology) optimization loop. The draft angle sculpting process can be applied by the CAD program(s) 116 in every iteration of the optimization loop, or in only some of the iterations of the loop, such as in several intermediate iterations early on in the optimization process, or only in later iterations after first allowing some free form modification of the three-dimensional shape of the modelled object. In any case, applying the draft angle sculpting process can eliminate overhangs and undercuts, which would trap the mold, and provide a proper draft angle that ensures the mold can be removed from the manufactured part.

For an input shape (or evolving, synthesized shape) the user 160 can specify a draft angle. In some cases, the draft angle can be selected by the CAD program(s) 116 based on knowledge of the manufacturing process and machine to be used to build the physical object. The user 160 can specify an ejection direction and/or a parting surface; note that a planar parting surface inherently specifies an ejection direction, and an ejection direction (along with a location along the ejection direction) can be used to specify a planar parting surface, since the ejection direction is normal to the planar parting surface. But the specified parting surface need not be planar, provided the surface divides the shape into two separate parts (i.e., the surface passes entirely through the shape), does not wrap back on itself (i.e., a ray cast along the ejection direction crosses the surface exactly once), and remains reasonably perpendicular to the ejecting direction throughout the design domain (e.g., up to ten, fifteen or twenty degrees of deviation from perpendicular). Further, in some cases, the ejection direction and/or parting surface can be intelligently guessed by the CAD program(s) 116, e.g., if not provided by the user 160, as discussed in further detail below. For example, the systems and techniques described in U.S. Pat. No. 11,914,929, entitled MULTI-BODY COMPONENT OPTIMIZATION, filed on Mar. 31, 2022, and issued on Feb. 27, 2024, can be used to determine a parting surface (e.g., parting plane) location.

The input shape is then updated to produce an output shape that satisfies the mold removal requirements, i.e., having no overhangs or voids and having the specified draft of vertical walls. As noted above, this update (application of the mold removability filter) can be performed within the iterative loop of a shape and/or topology synthesis algorithm. In the context of a level set topology optimization process, the shape synthesis process begins with a starting shape or “seed geometry” (either provided by the user or generated by an algorithm, such as the convex hull of the preserves) which is modified through successive iterations of an optimization loop to produce an “optimized design” or “final outcome” which minimizes some quantity of interest (e.g., strain energy) subject to some constraints (e.g., mass, max stress, and manufacturability). The optimization loop (in this example) involves numerical simulation, shape optimization, and advection. The numerical simulation performs a physics simulation of the current shape (e.g., compute strain energy everywhere inside the volume). The shape optimization transforms the result of the physics simulation (e.g., the strain energy field inside the volume) into a velocity field on the surface of the volume, where evolving the shape according to the velocity at each point moves the geometry towards a more optimal shape. Then, the advection updates the shape by moving each piece of the boundary according to its velocity. These three operations then repeat in a loop until the shape stops changing, or another exit condition is reached.

Shapes can be represented alternately by a grid of cubic voxels (for simulation), an implicit shape (for shape update) and optionally a polygonal mesh (for export, though a level set can be used for export as well). Shapes typically stay within a fixed design domain (also referred to as the design space 131) throughout the optimization process. Any user-specified regions of the design domain, called preserve bodies, are required to remain filled with material throughout the optimization process and can be used to specify boundary conditions on the physics problem (loads and constraints in solid mechanics, for example). In the context of shape synthesis, the mold removability filter can be applied immediately after the advection operation, thus making the shape compatible with a casting or molding manufacturing process at the end of each iteration of the loop in which the filter is applied. At the end of the shape optimization process, the output result can be a 3D model 132 with an associated parting surface 133, e.g., a parting plane in the example shown in FIG. 1.

The mold removability filter seeks to create a “nearest equivalent” shape to the one produced by the optimizer while satisfying the requirements of mold removability (undercut and void removal, and draft of vertical walls). However, while the mold removability algorithm(s) described in this patent application have particular benefits in the context of topology optimization and shape synthesis generally, they also have utility in several other contexts. The mold removability algorithm(s) can be used as a post-process on designs synthesized using topology optimization or some other process, such as an artificial intelligence (AI) driven shape design synthesizer, to make the output design more manufacturable. The mold removability algorithm(s) can be used as a pre-process for generating training data for an AI model, for example by taking a dataset of arbitrary parts and transforming them into the nearest equivalent castable components for the purposes of training the AI model to generate or discern castable designs. Finally, as noted above, the mold removability algorithm(s) can be used as an analysis tool to aid in locating regions of a design which are not castable.

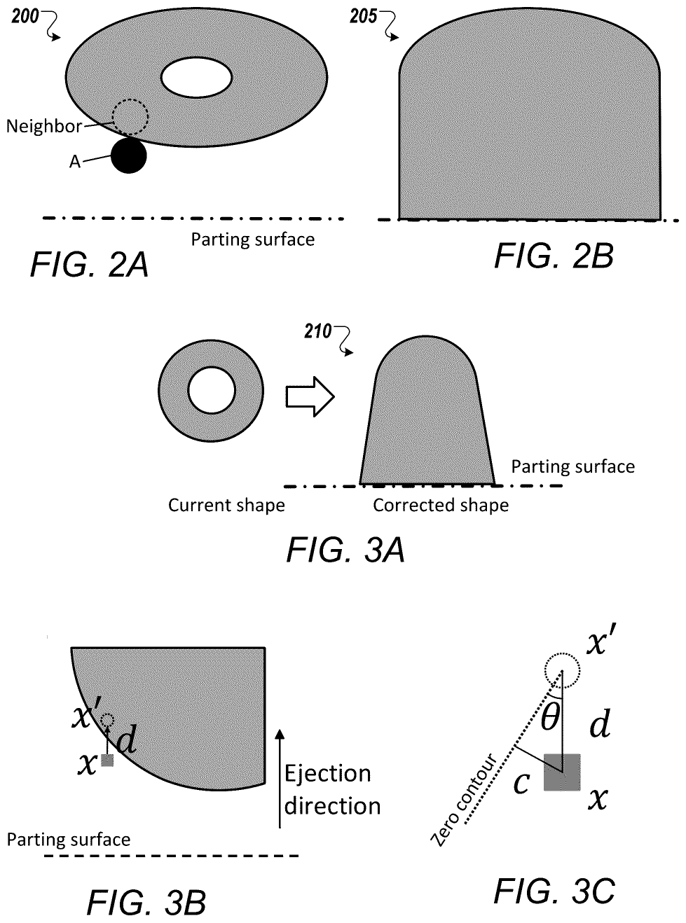

Conceptually, undercut and void removal can be achieved by ensuring that a point in space is in the interior of the part if its neighbor in the direction away from the parting surface is also in the interior of the part. FIG. 2A illustrates this: if material is added to all points like A, which are exterior to a shape 200 but have neighbors which are interior (where a neighbor is a point a predefined distance away in the direction away from the parting surface), a shape 205 which has no overhangs or interior voids, as shown in FIG. 2B is obtained. This conceptual model can be extended to introduce draft by further requiring that each point be slightly more interior than its away-from-the-parting-surface neighbor.

This can be implemented as a signed distance field update rule that is applied at each voxel in the sampled signed distance field which represents the shape, as shown schematically in FIGS. 3A-3C. FIG. 3A shows the intent of the algorithm, which will remove undercuts and voids and apply draft to produce a shape 210 from which the mold can be removed. Following the concept outlined above, for each voxel x in the design domain, the voxel's signed distance value is compared to the signed distance value of a “neighbor” point (x′) which is located a distance d away along a ray starting at x, parallel to the ejection direction, and pointed away from the parting surface, as shown in FIG. 3B. Note that when d is one voxel and the ejection direction is axis-aligned, x′ corresponds to an actual neighboring voxel, but this is not the case in general (the choice of d is an implementation decision, and the draw direction may not be axis aligned). In some implementations, d is set at a value of between 1.0 and 1.5 voxel widths (inclusive). Other values of d can be used in various implementations, such as values between 1.5 and 2.0 voxels (inclusive) or 2.0 and 2.5 voxels (inclusive).

FIG. 3C shows a schematic representation for a signed distance field update rule used to implement the mold removability filter. Note that an interpolation scheme can be applied to approximate the signed distance field value of x′ in the case that it does not lie exactly on a voxel. Further, having identified the signed distance field value at x (denoted ϕ(x)) and the (possibly interpolated) signed distance field value at x′ (denoted ϕ(x′)), the output signed distance field value at x can be set according to the update rule in Equation 1.

$$ϕ ( x ) ← min ( ϕ ( x ) , ( ϕ ( {x}^{′} ) + c ) \qquad ( 1 )$$

Equation 1 requires that the new signed distance field value be at least as small as the neighbor point's signed distance field value plus a (negative) constant offset c. Note that when c=0, overhangs and voids are removed from the design, and increasing the (negative) magnitude of c produces a drafting effect.

Specifically, c can be computed based on the schematic shown in FIG. 3C, in which it is imagined that the neighbor point x′ lies exactly on the zero contour. In the case where the signed distance field follows the draft constraint, the zero contour extends downward from the neighbor point with an angle θ from the ejection direction (this angle can be specified by the user as the amount of draft they require for the manufacturing process but can also be computed based on knowledge of the manufacturing process being utilized). The signed distance value at x should be c units away from this zero contour, where c is the shortest distance between x and the zero contour. The value of c can be computed from this right triangle as,

$$c = - d sin ( θ ) \qquad ( 2 )$$

adding the negative sign to ensure that x is on the shape's interior (negative signed distance field values are interior by convention in this context). By applying this rule to each voxel in the domain repeatedly until the shape stops changing, a new signed distance field is created that adds material to the original shape everywhere required to ensure undercuts are removed and draft is applied.

In some implementations, the signed distance field of the level set (which represents the geometry of the modelled object) is manipulated directly by a mold removability filter during shape and/or topology optimization. The mold removability filter can be applied in every iteration of the optimization loop, or in some cases, only in later iterations after first allowing some free form modification of the three-dimensional shape of the modelled object. In some implementations, an explicit parting surface is used, which need not be a flat plane in all implementations, rather than using a parting plane that is allowed to move arbitrarily in the design space.

The ability to define a parting surface corresponding to an ejection direction for the casting or molding manufacturing process is a difference with respect to the geometry filtering described in U.S. Patent Pub. No. US-2023-0152778-A1, entitled COMPUTER AIDED DESIGN WITH GEOMETRY FILTERING TO FACILITATE MANUFACTURING, filed on Nov. 1, 2022, and published on May 18, 2023, which is hereby incorporated by reference. Nonetheless, various systems and techniques described in this prior application can be used with the systems and techniques described in this patent application since the described draft angle sculpting process can be flipped to turn the mold removability filter into an additive overhang filter. Moreover, regardless of whether it is used as a mold removability filter or an additive overhang filter, the disclosed algorithm inherently accommodates draw or build directions that are not axis aligned. Nonetheless, the following description focuses on implementations that enforce mold removability (overhang removal and draft angle compliance) in a design for a part to be built using a casting or molding manufacturing process.

In some implementations, the algorithm can perform the signed distance field update in a single pass for any given side of a parting surface. The number of times the update rule need be applied to all voxels in the domain before the shape stops changing depends on the distance over which information must travel for the draft constraint to be satisfied. For example, a tall part (perpendicular to the parting surface) might require many more iterations than a shallow part before convergence is reached. The speed of the geometry filter can be improved by reordering the voxels based on their distance along the ejection direction such that every time a neighbor point is sampled, it only leverages voxels which have already been updated. By ordering this way, the number of passes over the domain can be reduced to one.

In some implementations, in order to efficiently (in terms of processing resources) compute a desired accuracy in the signed distance field, an adaptation of the techniques described in Zhao, A FAST SWEEPING METHOD FOR EIKONAL EQUATIONS, Mathematics of computation, Vol. 74, No. 250, pp. 603-627 (2005), can be used. Essentially, an ordered voxel traversal of the signed distance field in different directions can be performed in a manner that significantly improves speed of propagating the signed distance field away from the zero contour.

The technique(s) from Zhao can be used to expand a narrow band level set to cover the entire domain using an ordered traversal of the voxels. For example, six orderings of the voxels interior to the domain (i.e., not those on the outer surface of the voxel grid) can be computed, corresponding to both positive and negative traversals along each of the coordinate axes (i.e., +X, −X, +Y, −Y, +Z, −Z, where X, Y, and Z are the local coordinate system in which the voxel grid is contained). A kernel which updates a voxel by solving the Eikonal equation using a first-order upwind finite difference scheme is constructed, which adjusts the value of an input voxel based on the values of its neighbors to make the upwind gradient magnitude approximately 1.0. The kernel is applied at each interior voxel in each of the orderings successively, allowing the underlying signed distance field to be updated in-place. In some implementations, an outer loop performs the updates along each of the orderings more than once (i.e., each interior voxel in the domain can be updated once by each of the orderings in a series such as +X, −X, +Y, −Y, +Z, −Z, +X, −X, +Y, −Y, +Z, −Z, etc. for a pre-defined number of outer loop executions).

Finally, border voxels on the edge of the domain can have their values updated using neighboring interior voxels. An upwind finite difference scheme can be employed, but in some cases it is sufficient to set each border voxel equal to its nearest interior neighbor's value. Further, the algorithm that implements the Eikonal equation solution needed by the kernel, as described in Zhao, can be used in some implementations.

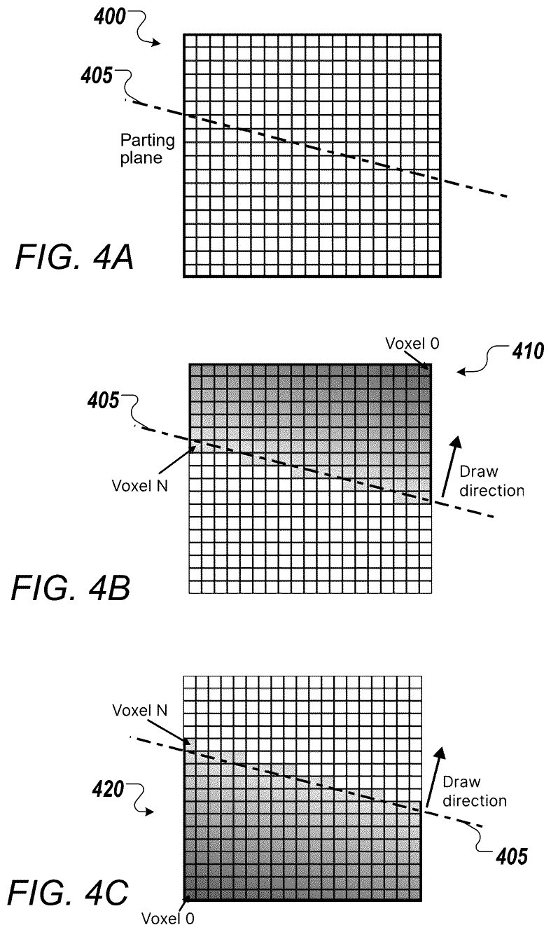

In some implementations, where the mold will have two parts separated by a parting surface, two “half” passes over the design domain are performed, one covering voxels above the parting surface ordered from the top of the domain down to the parting surface along the ejection direction, and a second pass that iterates over voxels on the lower half of the domain from the bottom up to the parting surface, as shown in FIGS. 4A-4C. Note that “up” and “down”, or “top” and “bottom”, are used as convenience terms to refer to different parts of the mold, under the general assumption that the part has been oriented such that the parting surface is roughly aligned with a horizontal plane. Additionally, in general, the “current” mold half is described as if it were oriented on the top half of the part, so that geometry “under” a particular point is closer to the parting surface and “over” implies further from the parting surface. These terms are used only to aid in clarity of this description and do not indicate that any such specific orientation of the part is required.

FIG. 4A shows a discretized design domain 400 with a parting plane 405. For the top half of the geometry, the process iterates from the voxel furthest along the positive draw direction backwards until all voxels which contain geometry on the top of the parting surface are processed, as indicated at 410 in FIG. 4B. These voxels are processed using the update rule, with neighbors located a small distance (e.g., distance d from FIG. 3C) along the positive draw direction. A second half-pass handles voxels below the parting plane, starting from the voxel furthest along the negative draw direction and iterating upward until all voxels on the bottom half of the parting surface have been processed, this time with the neighbor located along the negative draw direction, as shown at 420 in FIG. 4C. Note that a few voxels which are cut by the parting surface are processed twice, since they contain geometry on both halves of the model. Repeat applications of the update rule do not negatively impact the voxel's value. Moreover, in general, at least one pass will be performed per ejection direction to apply the mold removability constraint to the entire 3D model.

In practice, while the above approach satisfies the draft and overhang constraints, it can leave badly denormalized signed distance field values near the parting surface when geometry is projected downward towards the parting surface on one side but not the other in some regions of the model. A “denormalized” signed distance field occurs when the field ceases to accurately represent the distance to the surface (i.e., it becomes a level set in which the zero contour still represents the shape, but the values away from the zero contour may not have the correct magnitude to indicate an accurate distance to the zero contour). This denormalization can result in jagged or uneven features near the parting plane. To address this, an additional term can be included in the update rule that effectively Boolean intersects a signed distance field representing the half-space defined by the parting surface, creating a clean transition near the parting surface, as shown in Equation 3.

$$ϕ ( x ) ← min ( ϕ ( x ) , max ( ϕ ( {x}^{′} ) + c , h ) ) \qquad ( 3 )$$

$$h = \pm ( x - {p}_{0} ) \cdot \hat{d}$$

where h represents the half-space signed distance field and is defined based on the distance between the current point and a (closest) point on the parting surface p₀ projected onto the draw direction \hat{d}. In addition, the half passes can be extended to process voxels in a narrow band beyond (on the far side of) the parting surface to avoid discontinuities near any potential zero contours. Note that the sign of this term changes depending on which side of the parting surface is currently being processed such that h is positive on the side of the parting surface currently being processed.

The algorithm described above works for inputs which are represented by signed distance fields (i.e., implicit representations of a shape where at each voxel the true distance to the nearest surface is stored). Note that this does not restrict the applicability of the invention to inputs which are not signed distance fields, since any of a variety of tools can be leveraged to convert arbitrary input formats into signed distance fields. Further, in some implementations, only a narrow band representation of the signed distance field is computed and stored, i.e., valid distance information is only computed and stored in a band near the zero contour, with other regions left at an arbitrarily high distance. In shape and topology optimization algorithms, only a narrow-band (around the zero contour) signed distance field (e.g., between two and four voxels, or between two and ten voxels, on either side of the zero contour) is typically needed, which allows such algorithms to run faster. While this approach reduces processing resource usage, it has the downside that, when information flows through the update rule from regions outside the valid (narrow) band of the level set to the zero contour, artifacts can occur in the resulting shape.

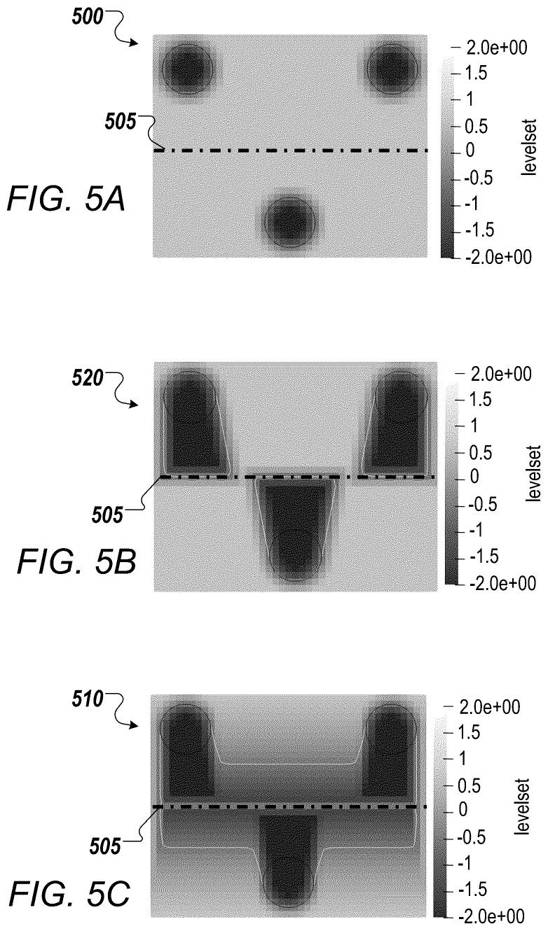

FIGS. 5A-5C show an example of implementations in which the input provided to the algorithm is a ±2 voxel narrow band, where the lines show the zero contour overlaid on the discretized signed distance field data structure, and the dashed line shows the parting plane. FIG. 5A shows an example of such an input signed distance field 500. One would expect the circular input shapes to be drafted down to the parting plane 505, as in FIG. 5B (the expected output), but when the algorithm is run, the result is as shown at 510 in FIG. 5C (the actual output without renormalization). The reason for this is that the update rule is applied to regions beyond the narrow band, which in these implementations, all have signed distance field values of 2.0 voxels, called the “background value”. When a voxel has a neighbor with a background value, it is updated to have a value slightly smaller than the background. After a few layers of traversal, what started as a background value has been reduced to 0.0, creating geometry in the output shape which was not related to the input shape (except perhaps in the shape of the bounding box used for the computation).

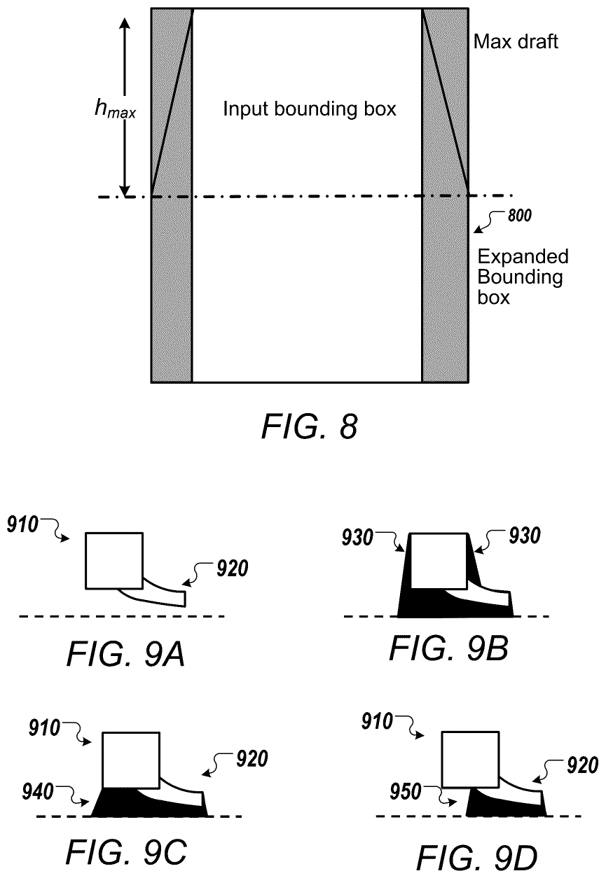

To address this issue, sufficient signed distance field data values (that are accurate) should be ensured to be present before applying the update rule such that no background voxels are updated enough times to cause artifact geometry. This can be done by renormalizing or extending the signed distance field outward to a larger band size. Mathematically, this requires a renormalization distance of hₘₐₓ sin(θ)+b, where hₘₐₓ is the maximum distance from the parting surface along the ejection direction of any domain element, and b specifies a buffer to ensure one stays significantly away from zero values at the parting surface (e.g., 2-3 voxel widths). Applying this renormalization as a preprocess and then running the update rule gives the result 520 shown in FIG. 5B. Note that the contours near the boundary of the domain in FIG. 5B are not drafted because the domain was not large enough to represent it. How to address this issue is discussed below in connection with FIG. 8.

Moreover, when the renormalization is performed for a parting surface that is a plane, the corner of the bounding box of the domain that is farthest from that plane is taken as hₘₐₓ. When the parting surface is not planar, the distance from that surface of each element in the domain (along the ejection direction) is checked in order to determine hₘₐₓ, which is the furthest any element in the domain can get from the parting surface.

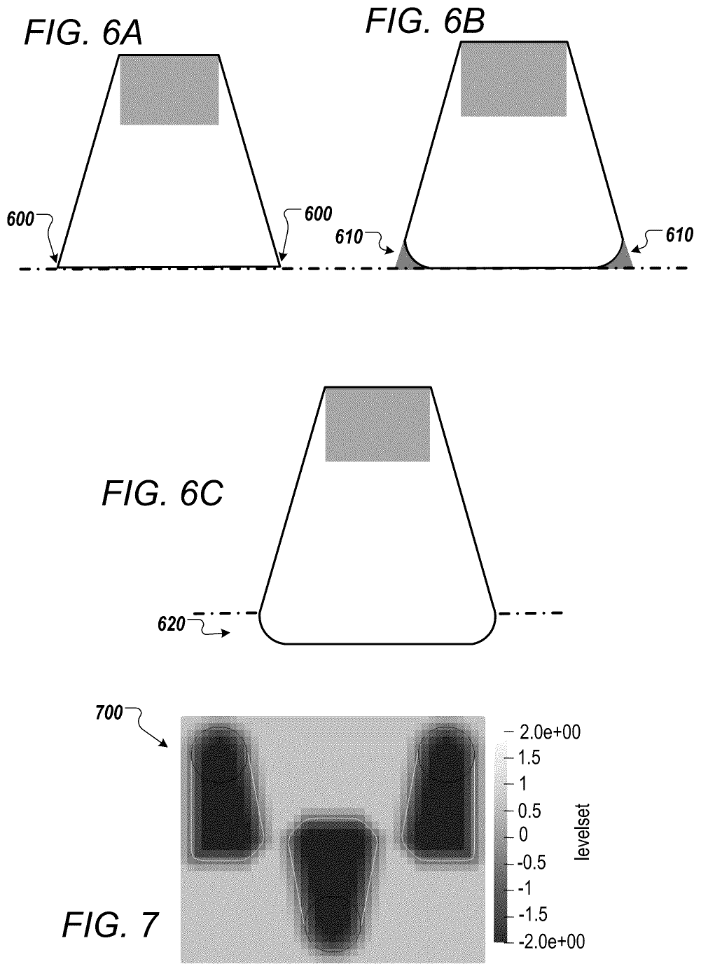

In cases where geometry is present in the input only on one side of the parting surface in a particular region, the algorithm described above will generate draft geometry down to the parting surface. While the signed distance field represents this contact crisply 600 at the sampling resolution, as shown in FIG. 6A, post-processing steps that smooth the shape (such as conversion to a surface mesh or T-Spline) can introduce undercuts 610, as shown in FIG. 6B, compared to the original output (before post-processing of the signed distance field). To address these undercuts, which reduce the manufacturability of the design, an optional modification is introduced to the behavior of the mold removability constraint/filter in the region of the parting surface. Instead of stopping the geometry exactly at the parting surface, the process can overshoot 620 slightly, penetrating into the other half of the mold pair, and a rounding (or reverse draft) can be added to ensure an undercut on the other side is not created, as shown in FIG. 6C (the corrected output).

This “overshoot” can be implemented by extending the traversal of the half-pass further beyond the parting surface by an additional “overshoot depth” D and adjusting the update rule in the overshoot region to ensure a new undercut is not introduced on the opposing mold. The adjusted update rule can take a variety of forms and can be as simple as switching the sign of c. In some implementations, an explicit rounding of the geometry is performed, and the definitions of c are updated according to Equation 4,

$$c = \{ \begin{matrix}- d sin ( θ ) & h > 0 \\ min ( \frac{{dDh}^{2}}{{Δ}_{x}^{3}} sin ( θ ) , {Δ}_{x} ) & h \leq 0\end{matrix} \qquad ( 4 )$$

where h is the distance above the parting surface (negative indicates below the parting surface) for the current mold half as described in Equation 3, Δₓ is the width of one voxel, and D is an overshoot depth, which describes the distance beyond the parting surface to extend the geometry and is defined in Equation 5,

$$D = max ( 0.05 l , 3 {Δ}_{χ} ) \qquad ( 5 )$$

with l being a characteristic length of the domain (in some implementations, the smaller of half the diagonal of the bounding box and the smallest dimension of the bounding box). Applying this correction to the example problem from FIGS. 6A-6C results the shape 700 shown in FIG. 7, where the overshoot prevents undercuts near the parting surface. Note that other implementations of the adjusted update rule are also possible, as will be apparent from the described implementations.

The examples shown in FIGS. 5A-5C and FIG. 7 have un-drafted geometry (vertical walls) near the boundary of the domain because the size of the domain is not adjusted to account for the addition of draft. Because draft geometry extends outwards from the input geometry as it approaches the parting surface, in practice it frequently tries to grow outside of the optimization domain when the ejection direction is (nearly) axis aligned. This issue can be readily addressed, as now described in connection with FIG. 8, which shows that bounding box expansion 800 depends on the maximum height of the part.

At the beginning of the process (or at any point during the process) the maximum lateral extension of the domain caused by applying draft can be computed based on the draft angle and the maximum distance between any point on the bounding box and the parting surface, as shown in FIG. 8. Mathematically, the bounding box should grow in the direction perpendicular to the parting surface normal by an amount of at least hₘₐₓ tan(θ). In the event that the parting surface is not roughly parallel to one of the faces of the bounding box, it is likely possible to reduce the amount of domain expansion, so long as the largest representable shape (i.e., the input bounding box is full of material) satisfies the draft constraint.

In some implementations, the bounding box of the domain is not adjusted to account for possible additional draft geometry. Instead of adjusting the domain bounds, a fix can be applied to ensure that the shape remains contained in the bounding box by performing a Boolean Intersection between the shape produced by the update rules described above and a box roughly two voxels smaller than the bounding box after the update and before returning the result (e.g., to the user). This ensures that the design stays within the representable domain and avoids artifacts that might otherwise be introduced (at the expense of locally violating the draft constraint in regions up against the domain bounds). Nonetheless, in some implementations, domain bounding box expansion is performed as described above.

Further, one deficiency of a previous casting constraint in generative design was its tendency to produce artifacts on the surface of preserves as a result of the generation of draft geometry on preserve faces which were parallel to the ejection direction. These draft regions frequently produced undesirable regions of organic geometry in a place where a parametric draft constraint would be better suited to ensure manufacturability of the preserves. To address this issue, in some implementations, a feature is included that allows special handling of preserves for the mold removability constraint/filter.

For example, FIG. 9A shows an input that consists of two regions of geometry: a preserve 910 and some organic/optimized geometry 920. Without further modifications, the mold removability constraint/filter is applied to both preserve 910 and generated (organic) geometry 920, generating the result shown in FIG. 9B: note that this creates slivers 930 of organic draft geometry along the vertical faces of the preserve 910, which is undesirable. Modifications described in this section enable the mold removability constraint/filter to be applied only along the bottom face of the preserve (but not the sides) and the generated organic geometry (as shown in FIG. 9C) or only to the organic geometry (completely ignoring the preserve, as shown in FIG. 9D), depending on the user request or some automatic selection by the program.

To provide these modifications, one or more regions of the design should be designated for special handling of the mold removability constraint/filter. In some implementations, these regions are the preserve bodies or thickened preserve surfaces. In some implementations, preserve bodies participate in only undercut and interior void removal, but not draft, to produce added material 940 as shown in FIG. 9C. In some implementations, the user can specify where to apply undercut and interior void removal without draft (recall that the same algorithm can perform this by setting the draft angle to zero). In some implementations, the program determines the degree to which to apply the mold removability constraint/filter based on the geometry or location of the preserve (or other features). Further, note that preserves which are handled specially can create regions of undercut or vertical walls in the final design which violate the mold removability constraint. These can be addressed by the user in a downstream process through additional geometry modifications or by using a more complex mold design to accommodate the overhang (such as a core or slide).

Applying the mold removability constraint/filter to only some of the input geometry can be achieved with an additional preprocessing step depending on the kind of handling desired. In the case of no-draft of preserve bodies (to produce added material 950 as shown in FIG. 9D) a Boolean subtraction can be performed to exclude preserve bodies from the draft computation, thus removing the non-participatory geometries (preserves) from the input shape. Note that to avoid numerical issues, the preserve bodies can be first offset outwards by a small amount, e.g., 0.5 voxel. Once the preserve bodies are removed, the mold removability constraint/filter application can proceed, and then the preserve bodies are reintroduce in the output through a Boolean union. In practice, instead of explicitly Boolean unioning in the preserves, the corrected (output) shape can be unioned with the input shape, which has a side benefit of guaranteeing that the constraint did not remove any material from the input shape.

In the case of partial-draft of preserve bodies (bottom faces only, as shown in FIG. 9C) instead of removing the draft geometry from under the preserves entirely, the undesirable artifacts discussed in relation to FIG. 9B can be addressed by permitting vertical walls in preserve geometries and only applying overhang correction (overhang-corrected areas will still receive draft). To do this, a “skin” geometry can be created that corresponds to the overhanging regions of the preserve bodies. The preserves can be removed with the same approach described in the “no-draft of preserve bodies” case above, then the skin geometry can be Boolean unioned into the shape before applying the mold removability constraint/filter.

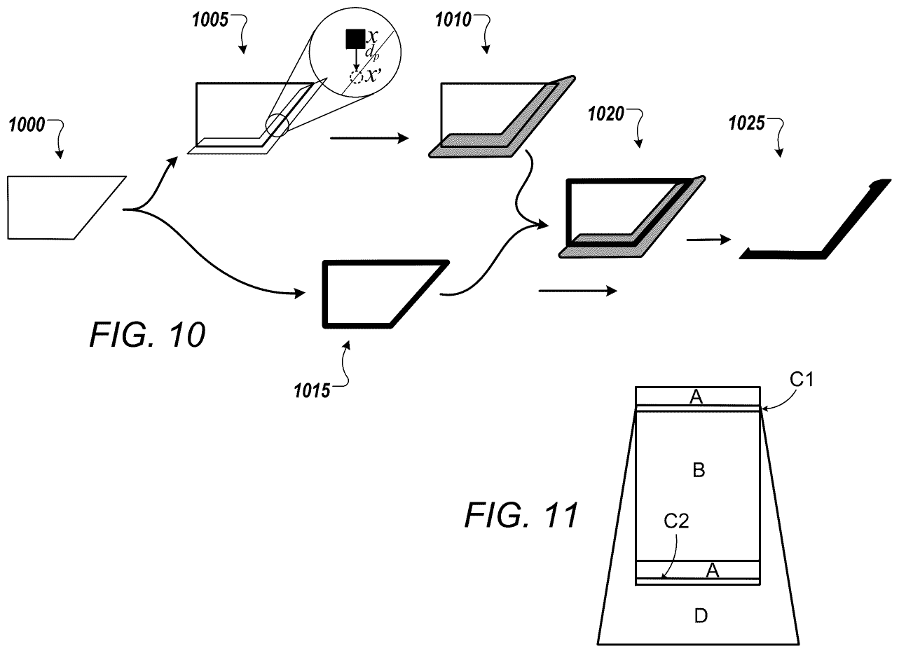

The skin body can be created in the following manner, with reference to FIG. 10. At 1000 in FIG. 10, an example input preserve is shown; only the preserve body is drawn in this example, as this transformation happens only on preserves. First, a “mask” of the overhanging regions of the preserve is created, as shown at 1005 in FIG. 10, creating a binary grid where a 1 indicates a voxel inside the mask and a 0 indicates an exterior voxel.

The mask is created by examining each voxel in the domain and using a check similar to the update rule employed in the main mold removability constraint: for each voxel, compare the value of the preserve signed distance field at this point (ϕₚ(x) for x at 1005 in FIG. 10) with the value sampled a set distance below the current voxel towards the parting surface (ϕₚ(x′) for x′ at 1005 in FIG. 10). The distance (dₚ) can be set as 1.0 voxel width. The difference between these signed distance field values is compared to a threshold such that if ϕₚ(x′)−ϕₚ(x)>t, where t is a small positive threshold value describing the maximum allowed overhang before a near-vertical wall is considered “overhanging”. Using t=dₚ sin(3°) permits an overhang of up to 3°. If a voxel:
1. satisfies the overhang check (if ϕₚ(x′)−ϕₚ(x)>t), and
2. is within a band of the preserve field boundary (the band should be smaller than the available bandwidth of the preserve signed distance field by at least dₚ), it is assigned a value of 1.0 in the mask field. All other voxels receive a value of 0.0.

The mask is then converted to a signed distance field (item 1010 in FIG. 10) by shifting and scaling the mask field such that it becomes a level set field, which is then renormalize to create a signed distance field and offset outwards to expand the mask a bit beyond the overhanging region. In some implementations, an outward offset of 2.0 voxel widths is used. An example of an algorithm that can be used to achieve this mask-to-signed distance field conversion with a specified outward offset in the context of a voxel grid where each voxel has edge width Δx is given below:
1. Multiply the mask value by −2 Δx*(1+offset)
2. Add (1+offset)*Δx
3. Laplacian smooth (4 iterations)
4. Renormalize the field to form a signed distance field out to at least (1+offset)*Δx
5. Add −offset*Δx to each signed distance field value (this achieves the offset).

Alongside the mask signed distance field (optionally in parallel) a signed distance field is computed for a shell of the preserve shape (item 1015 in FIG. 10). The shell is created by taking a copy of the preserve signed distance field and subtracting an offset of the same, where the offset corresponds to the shell width. For example, a shell width of 2.0 voxel widths can be used. The mask and shell fields are then combined using a Boolean intersection (items 1020 and 1025 in FIG. 10) to produce the skin geometry.

In practice, this partial-draft algorithm works, but some thin artifacts are still present, for example when a preserve surrounds an obstacle with its axis perpendicular to the ejection direction. FIG. 11 shows a schematic of what is happening in this situation. The preserves (A) and obstacles (B) are provided, and a preserve skin (C1 & C2) is computed, which is included in the mold removability filter, adding geometry D to the design. Because the obstacle (B) is subtracted out after the mold removability filter is finished, thin shards of geometry remain, depending on the resolution of the signed distance field's sampling.

To address this issue, an additional check can be introduced in the mask computation step presented above to only generate preserve skin in regions where the preserve is not immediately above an obstacle (i.e., immediately adjacent to an obstacle in the direction of the parting surface). This behavior can be achieved by adding an additional check before marking a mask voxel as 1.0, which steps iteratively from the current voxel downward towards the parting surface for a specified distance (e.g., 3, 4, or 5 voxels), and samples the obstacle signed distance field, searching for a point which is less than a threshold distance from the obstacles. The threshold used is a small fraction of a voxel width (e.g., 0.2, 0.3, or 0.4), plus an adjustment which is the larger of the current voxel's signed distance from the preserve body and zero. The motivation for this adjustment is to enable correct detection of obstacles even when in the narrow band adjacent to a preserve, which avoids slivers of mask voxels appearing at the edges of preserves which are fully adjacent to obstacles of the same size. Further, this search step can be added as a requirement for selecting a mask voxel, i.e., no obstacles are detected using the obstacle detection search defined above.

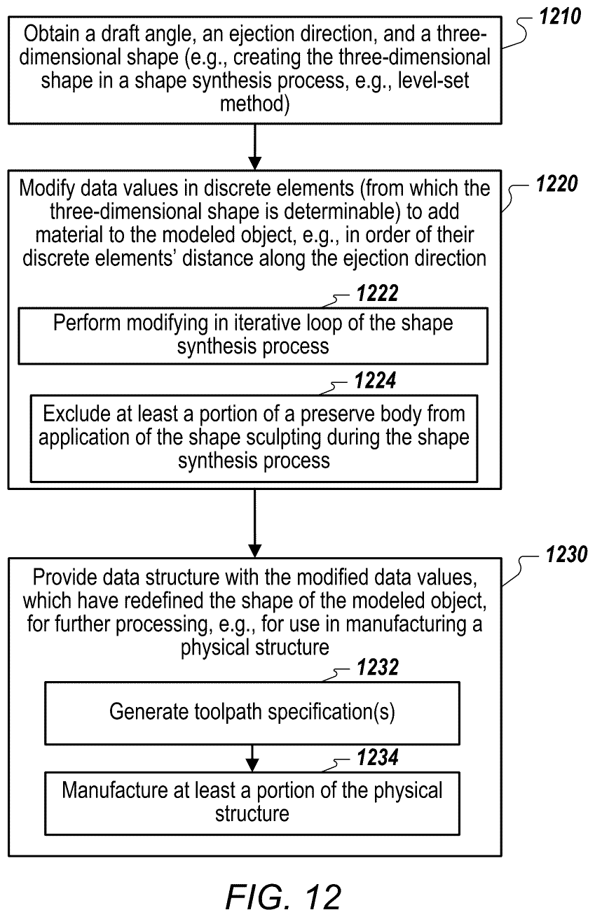

Further examples of processes are provided below in connection with FIG. 12. In any case, and returning to FIG. 1, the 3D model 132 that is produce can be stored as 3D model document(s) 130 and/or used to generate another representation of the model (e.g., toolpath specifications for a manufacturing process). This can be done upon request by the user 160, or in light of the user's request for another action, such as sending the automatically generated 3D model to a manufacturing machine 170, which can be directly connected to the computer 110, or connected via a network 140, as shown. This can involve a post-process carried out on the local computer 110 or externally, for example, based on invoking a cloud service running in the cloud, to further process the generated 3D model (e.g., based on considerations associated with the manufacturing process) and to export the 3D model to an electronic document from which to manufacture.

Note that an electronic document (which for brevity will simply be referred to as a document) can be a file, but does not necessarily correspond to a file. A document may be stored in a portion of a file that holds other documents, in a single file dedicated to the document in question, or in multiple coordinated files. In addition, the user 160 can save or transmit the 3D model for later use. For example, the CAD program(s) 116 can store the 3D model document(s) 130 that includes the generated 3D model.

Also note that the 3D model 132 represents the part to be manufactured using casting or molding, and so the toolpath specifications will be for use in constructing a mold that is then used to manufacture the physical structure corresponding to the 3D model, such as mold cavity 138 to be used with injection unit 139. As will be appreciated, different types of casting or molding manufacturing processes can be employed, such as die casting, sand casting, permanent mold casting, compression molding, extrusion molding, and injection molding. Likewise various types of manufacturing machines 170 can be used to build the mold, such as computer numerical control (CNC) machining or electric discharge machining (EDM). In any case, the CAD program(s) 116 can provide a document 135 (having toolpath specifications of an appropriate format) to the manufacturing machine 170 to create at least a mold cavity from stock material, where the shape of the physical structure to be manufactured with that mold cavity includes the optimized topology and/or shape that facilitates the casting or molding manufacturing process.

FIG. 12 shows an example of a process employing draft angle sculpting, such as during shape synthesis, to produce physical structures with designs that are tailored to facilitate manufacturing using casting or molding processes. A draft angle, an ejection direction, and a three-dimensional shape of a modelled object are obtained 1210, e.g., by CAD program(s) 116 or 3D modeling program(s) 1504. The modelled object can be for a corresponding physical structure that can be manufactured using a casting or molding process, where the draft angle and the ejection direction are for the casting or molding process. The three-dimensional shape of the modelled object can be defined within a design domain by a data structure having discrete elements (e.g., voxel or tetrahedral mesh elements) holding data values from which the three-dimensional shape of the modelled object is determinable.

The data values in the discrete elements can be modified 1220, e.g., by CAD program(s) 116 or 3D modeling program(s) 1504, to add material to the modelled object. The modifying 1220 can include, for each of the discrete elements, changing a current value of the discrete element based on a comparison of the current value with another value and a constant value, the other value being determined from one or more values found in one or more other discrete elements in the data structure located away from the discrete element along the ejection direction. For example, values of voxels can be aggregated along the ejection direction, such as by scanning for a minimum value over adjacent voxels with a correction based on the local gradient and/or extrapolating when near the domain boundary to seek an accurate measure. Further, the constant value is determined for the draft angle.

Additional details of examples for determining the constant value and the other value are provided above in connection with FIGS. 3A-3C. In some implementations, the other value is determined at a point located a predefined distance away from the discrete element along the ejection direction (e.g., a hard coded distance, or a distance that varies depending on one or more other quantities, such as the current signed distance field value of the discrete element and/or the distance from the parting surface). In some implementations, the other value is determined at the point by interpolating data values found in two or more other discrete elements in the data structure that surround the point (e.g., using tricubic interpolation, trilinear interpolation, or another suitable form of multivariate interpolation). Note that using interpolation in this manner enables the shape sculpting process to handle any orientation of the ejection direction. In general, the other value provides some measure of the state of the shape away from the current element in the ejection direction, which is then used to update the current element.

In some implementations, the modifying involves modifying the data values in order of their discrete elements' distance along the ejection direction from a surface. This ordering can be determined, for example, by sorting tetrahedral elements in the data structure or by sorting voxel elements in a data structure that stores them by encoding their locations explicitly (instead of implicitly like most voxel representations do where their location in the structure defines their physical location), or by creating a sorted ordering in an auxiliary ordering data structure, for voxels or tetrahedral elements, that indicates the order of processing the element, while leaving the original data structure intact. Further details regarding ordering are provided above in connection with the adaptation of the techniques described in Zhao.

In some implementations, the surface is a parting surface, and the modifying 1220 is performed for each side of the parting surface and extending thru the parting surface, and the changing is further based on a comparison of the other value plus the constant value with a further value. This further value is determined based on a distance between the parting surface and the discrete element. Further details regarding determining and using this further value are provided above in connection with using the half-space defined by the parting surface to address denormalization.

In some implementations, extending the modifying 1220 thru the parting surface involves extending by an overshoot depth and adjusting the changing inside the overshoot depth. In some implementations, the data structure holds valid signed distance field values only in discrete elements falling within a predefined distance of a zero contour of a current version of the three-dimensional shape of the modelled object, e.g., a narrow band representation of the signed distance field, and the signed distance field is extended outward based on the draft angle and a maximum distance from the parting surface of any domain element. Moreover, in some implementations, before the modifying 1210, the discrete elements are added to by an amount determined from the geometry of the draft being created and the shape of the design domain and parting surface to ensure drafted final shape can be fully represented in the data structure. Further details regarding such extending and adjusting, extension of the signed distance field, and adding to the discrete element are provided above in connection with FIGS. 5A-8.

In some implementations, rather than extending a narrow band representation of the signed distance field, a condition can be added to the update rule that does not change the current voxel's value if the neighbor is more than the narrow bandwidth away from the zero contour. This will cause the structure to only be partially drafted since regions that would be updated based on signed distance field values far from the zero contour would not be present here, but the draft would get progressively better on subsequent iterations of the topology optimization loop as the signed distance field's narrow band grows outwards a little bit on each iteration due to the effect of the mold removability filter. Usable results can be achieved with this iterative approach, without requiring a wide band signed distance field, thus reducing the amount computation resources needed since a narrow band representation of the signed distance field can be used throughout the shape synthesis processes.

In some implementations, the obtaining 1210 involves creating the three-dimensional shape in a shape synthesis process, and the modifying 1220 is performed 1222, e.g., by CAD program(s) 116 or 3D modeling program(s) 1504, within an iterative loop of the shape synthesis process. The shape synthesis process can operate using one or more design criteria, e.g., design objective(s) and design constraint(s) for the object. Design objectives can include but are not limited to minimizing waste material, minimizing the weight of the part, and minimizing the compliance, stress, or other intrinsic property of the part, and are used to drive the shape synthesis process towards better designs. Though not required, it is typical for a design objective to be rooted in a simulation of the design, e.g., linear static, fluid dynamic, electromagnetic, etc. Design constraints can include a variety of geometric and physical characteristics or behaviors that should be met in any generated design (requirements either on individual parts or on the entire assembly are also admissible); examples include maximum mass, maximum deflection under load, maximum stress, etc.

The one or more design criteria can also include geometric objectives for the shapes and geometric constraints. The geometric constraints can be provided by a user or from the CAD program(s) 116 to ensure certain characteristics of the shape are realized, e.g., to provide a shape that is easier to manufacture. The input geometry can include details for preserve bodies that should be present in the design as representing interfaces to other parts of the system or identify locations on which boundary conditions should be applied (e.g., mechanical loads and constraints). Moreover, in some implementations, at least one portion of at least one preserve body is excluded 1224, e.g., by CAD program(s) 116 or 3D modeling program(s) 1504, from being operated on by the modifying 1220, e.g., during the shape synthesis process.

The shape synthesis process can be a structural generative design process that has associated boundary conditions, e.g., boundary conditions associated with mechanical loads such as force, moment, pressure, etc., and mechanical constraints such as fixed, bearing, pin, etc., which can specify in-use load case(s) of the physical structure. Other types of automated design processes can be employed. Nonetheless, the shape synthesis process can employ a boundary-based approach, where a boundary-based computer-data representation of a three-dimensional shape of the modeled object is used, rather than a density-based approach, such as a Solid Isotropic Material with Penalization (SIMP) method. In some implementations, the boundary-based computer-data representation is a level-set computer-data representation; note that the shape synthesis process can use a level-set topology optimization method.

Regardless of whether or not a shape synthesis process is used to create the shape of the modeled object, the modifying 1220 results in new data values in the data structure for the modeled object, where those new data values redefine the three-dimensional shape of the modelled object within the design domain so as to satisfy the draft angle for manufacturing using a casting or molding manufacturing process. This data structure with the modified data values is provided 1230, e.g., by CAD program(s) 116 or 3D modeling program(s) 1504, for further processing, such as for use in manufacturing a physical structure corresponding to the modeled object using the casting or molding process.

The providing 1230 can involve sending or saving the three-dimensional model to a permanent storage device for use in manufacturing the physical structure corresponding to the object using one or more manufacturing systems. In some implementations, the providing 1230 involves generating 1232, e.g., by CAD program(s) 116 or 3D modeling program(s) 1504, toolpath specifications for computer-controlled manufacturing system(s) (a subtractive manufacturing machine and/or an additive manufacturing machine) using the data structure with the modified data values. Further, the providing 1230 can involve manufacturing 1234, e.g., by CAD program(s) 116 or 3D modeling program(s) 1504, at least a portion of a mold for the physical structure with the computer-controlled manufacturing system(s) (the subtractive manufacturing machine and/or the additive manufacturing machine) using the generated 1232 toolpath specifications, where the portion of the mold is a negative of a portion of the physical structure. Moreover, the providing 1230 can involve manufacturing 1234, e.g., by CAD program(s) 116 or 3D modeling program(s) 1504, at least a portion of a doppelganger of the physical structure with the computer-controlled manufacturing system(s) (the subtractive manufacturing machine and/or the additive manufacturing machine) using the generated 1232 toolpath specifications, where the at least a portion of the doppelganger of the physical structure is usable to form at least a portion of a mold for the physical structure, e.g., as in sand casting. Note that it is not uncommon to create the mold parts by casting or molding mold material around the doppelganger, sometimes with additions to aid in the casting process such as vents and fill ports, which can be created digitally in the CAD model and manufactured with the doppelganger or manually by an operator as part of mold preparation. Further, this approach can extend the doppelganger technique to other casting and molding processes.

In addition, although the above description has focused on the context of shape synthesis for physical object to be manufactured using casting or molding processes, other applications of the described systems and techniques are also possible. The algorithm can be used to ensure a proper build angle for additive manufacturing; note that the functional draft angle for additive manufacturing will be negative, and so the following relationship can be applied: [functional draft angle]=[additive overhang angle]−90 degrees. Further details for implementations that employ the present systems and techniques as a build-angle filter can be found in U.S. Application No. 63/709,078, filed Oct. 18, 2024, and in U.S. Application No. TBD, filed TBD under attorney docket no. 15786-0399001, both entitled, “BUILD-ANGLE FILTERING DURING SYNTHESIZING OF THREE-DIMENSIONAL MODELS OF PHYSICAL OBJECTS FOR ADDITIVE MANUFACTURING PROCESSES”, and both of which are hereby incorporated by reference.

Further, the present systems and techniques can be applied to generative AI models seeking to synthesize, classify, or modify designs which are intended for manufacture with casting or molding processes. In particular, applications to data synthesis and processing for training AI models and to postprocessing of shape synthesis achieved by generative AI are possible. For training AI models, large amounts of data are required when training generative AI models, and the set of 3D CAD designs which are designed for molding or casting and are correctly tagged for training is small. The present systems and techniques can improve training data in two ways: by improving the quality of the labeling of a training set by automatically verifying whether or not a design can be manufactured with a casting or molding technique, and by synthesizing training data which is castable from a database of not-necessarily-castable 3D models.

The mold removability constraint/filter can be leveraged in a labeling task by using it as a classifier. Given an input 3D model in the training dataset, a parting surface and one or more ejection directions (these can be guessed from the model structure using any of a variety of heuristics), the mold removability constraint can be run and create a constrained version of the model. If the geometric difference between the input and the constrained model are minimal, then the input 3D model satisfies the mold removability constraint and should be labelled as manufacturable. Note that while other techniques can readily assess draft in 3D CAD geometry, undercuts are much harder to detect with existing techniques. Since the presence of draft alone is not sufficient to identify a part as being castable, the mold removability constraint-turned-classifier can provide a significant advantage.

Moreover, a common activity in AI training data gathering is to synthesize a larger training set from a smaller one. In this case, it is possible to automatically apply the mold removability constraint/filter to a database of training models which are not castable per se, in order to create a new database of castable models suitable for training tasks. Note that again a heuristic is needed to select one or more appropriate parting surfaces for each input model.

Another application of the present systems and techniques to generative AI is as a post-processor for generatively synthesized designs. Generative AI has demonstrated remarkable capabilities in creating shapes, but the shapes do not necessarily allow for easy manufacturing. One possible approach to improve the utility of generative AI results is to use a manufacturing constraint such as the mold removability constraint/filter to convert the generated design into one more suitable for manufacturing. In this application, the mold removability constraint/filter can be applied either directly to the output of a generative AI algorithm to produce a level set of a more manufacturable version of the design. This can either be used directly as output to the user (for example by leveraging level set to B-Rep conversion technology), or provided as input to a second AI model which can convert the resulting level set shape into a B-Rep feature tree.

In addition, the present systems and techniques can be used with cores and slides, where there are more than two draw directions for the 3D model. Having more than two opposing mold halves is commonly done in casting and molding practice and takes the form of “cores” or “slides”, which are additional mold components that are removed after (respectively, before) the main mold halves after the casting operation is complete. Usually, cores and slides have a different ejection direction than the main mold halves. Additional mold components with different ejection directions can be handled using the present systems and techniques by repeating the update rule calculation for the new ejection direction (e.g., in parallel with the main mold computation) to produce a second version of the design which can be cast using only the new ejection direction (note that slides and cores usually consist of single mold elements and thus do not have a parting surface; the draft continues all the way to the bottom of the part in this case).

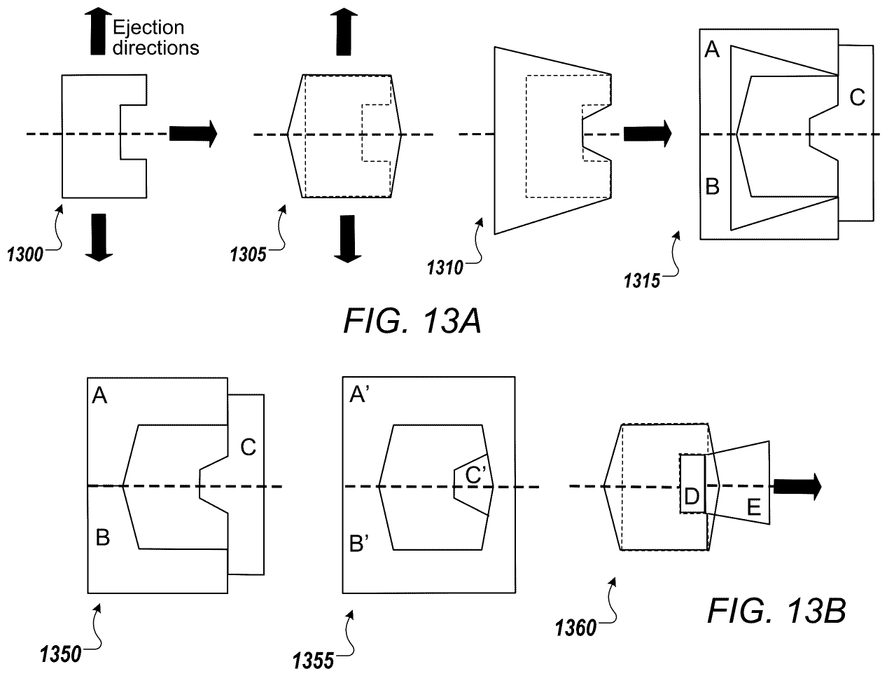

For example, the part represented by input shape at item 1300 in FIG. 13A can be manufactured using two primary mold halves as well as a core with an ejection direction from the right. Item 1305 in FIG. 13A shows the result of applying the update rule for the two mold halves associated with the primary ejection direction, to produce a first intermediate shape. Item 1310 in FIG. 13A shows a second intermediate shape, created by applying the update rule along the core ejection direction with no parting plane (note that this causes the draft to extend below the bottom of the part, all the way to the domain boundaries). Then, the two intermediate shapes are combined with a Boolean Intersection to produce the final shape shown in item 1315 in FIG. 13A. The mold shapes are shown in the regions labelled A, B, and C in FIG. 13A.

This procedure can be repeated for additional core/slide ejection directions, with each producing an additional intermediate shape that is included as an input to the final Boolean intersection. Note that this approach to multiple molds shares significant implementation similarities with the approach used for more than two milling directions in the extensions of U.S. Pat. No. 11,409,262, entitled COMPUTER AIDED GENERATIVE DESIGN WITH FILTERING TO FACILITATE 2.5-AXIS SUBTRACTIVE MANUFACTURING PROCESSES, filed on May 18, 2020, and issued on Aug. 9, 2022, which is hereby incorporated by reference.

In some applications it is desirable to minimize the size of the cores or slides. For example, for item 1350 in FIG. 13B, it is likely the mold will be less expensive to make and operate if the size of the core is reduced to only those regions where it adds significant value to the part, as in item 1355 in FIG. 13B, in which alternate mold shapes are shown in the regions labelled A′, B′, and C′. The regions in which a core or slide adds value can be heuristically determined by examining the intermediate result from the primary attack directions. If the signed distance fields from the input shape and the corrected intermediate shape are compared, region D (shown at item 1360 in FIG. 13B) can be identified as a place where the input is significantly different than the corrected shape. This region can be projected outwards along the core ejection direction to define a region of interest or region of applicability for the core (a projection region E).

In some cases, an additional check may be needed to ensure that the projection region E does not intersect significant portions of the input geometry. For example, an algorithm can create the projection region E given the significant change in region D and the ejection direction in a way that avoids D or E intersecting preserve regions as follows. An update rule of the same style as applied in the main draft constraint can be used. Ordering the voxels so that they are evaluated according to their distance along the core ejection direction (i.e., moving from D to E in item 1310 of FIG. 13B), each voxel can be iteratively updated, setting its value equal to the larger of a neighbor value sampled one voxel along the negative ejection direction plus c (the constant describing the outward draft) and the negative sample value of the input shape at the current voxel. This creates the projection region E in item 1360 of FIG. 13B with an outward draft, leaving a “shadow” under any intersecting geometry from the input shape. The region of interest level set can then be renormalized and offset outward slightly.

It is possible that the input shape and ejection direction selected cause the core to produce relatively little impact on the part, for example if the input geometry “blocks” or overhangs significant portions of the region D. The amount of impact a core has on the final design can be evaluated by performing the draft correction along the core's ejection direction with the core's region of interest as a mask which restricts where the update rule is applied, then comparing the intersection of the corrected shapes from all ejection directions and from all ejection directions except for the core (i.e., compare the volume of item 1305 intersected with item 1310 in FIG. 13A with the volume of item 1305). If the two geometries compare and have minimal volume change, the core is not valuable and can be removed to simplify the mold design.

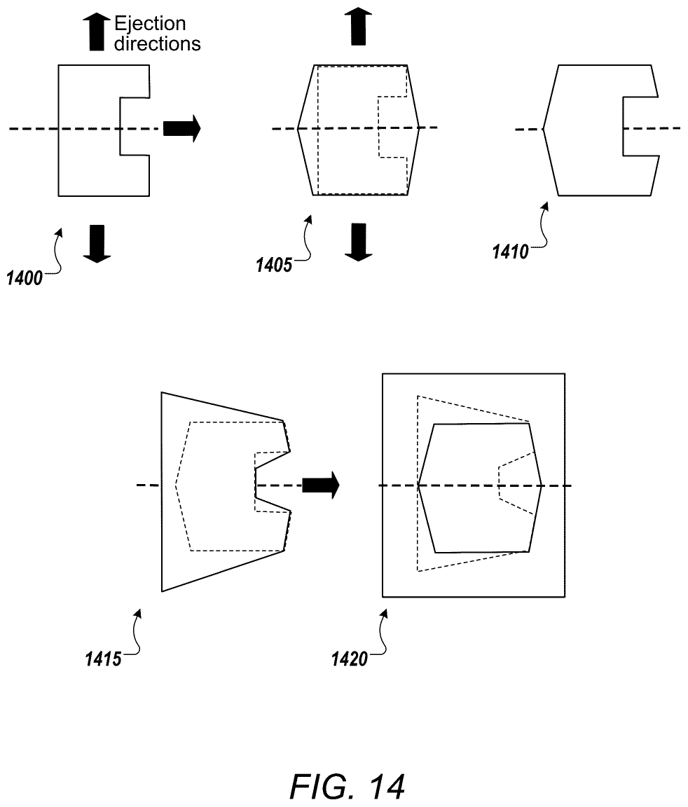

In any case, the algorithm can be adjusted as follows: instead of directly computing the second intermediate shape (item 1310 in FIG. 13A), the region of interest (D and E) can be Boolean subtracted from the intermediate shape item 1305 of FIG. 13A, then the update rule is applied to correct this new shape, using this instead of the original second intermediate shape as input to the final Boolean intersection. For example, FIG. 14 shows a part with a single core which utilizes a region of interest to restrict the size of the core. Items 1400 and 1405 in FIG. 14 are as before (i.e., the same as items 1300 and 1305 in FIG. 13A. Item 1410 in FIG. 14 shows the intermediate from item 1405 in FIG. 14, with the region of interest for the core removed (by Boolean subtraction). In item 1415 of FIG. 14, this new shape is corrected using the core's ejection direction, and the two intermediate shapes are intersected to create the final design, i.e., item 1405 in FIG. 14 is intersected with item 1415 in FIG. 14 to result in item 1420 in FIG. 14.

While the examples in this section present only a single additional ejection direction, the procedure can be extended to multiple cores and slides by repeatedly computing the corrected form of the shape (either the original shape as in item 1310 of FIG. 13A, or an intermediate as in item 1405 of FIG. 14, if regions of interest are used) and iteratively intersecting the results to produce a final design.

Furthermore, rather than have the user specify the parting surface and ejection direction, the selection of the parting surface and ejection direction can be done by the program in some implementations, as a pre-processing of a geometry before filter application or as an auxiliary design variable in shape synthesis (e.g., a topology optimization) context. In the following description, it is presumed that the parting surface is a plane and the ejection direction is normal to that plane. For simplicity, only two-part molds (no slides or cores) are considered, but the ideas presented here can be extended to more complex configurations.

Either before the moldability constraint is applied, or at the beginning of a shape synthesis process, heuristics or optimization techniques can be used to select a “best guess” parting plane location (with ejection direction derived from the parting plane normal). Heuristic approaches use properties of the input shape to estimate a best orientation and location for the parting plane. Heuristic approaches can include: (1) select the parting plane so as to minimize the maximum distance from the parting plane to the part geometry (i.e., placing it at the midplane of the input shape with its normal along the minor axis), (2) select the parting plane normal by analyzing the area of the input shape's shadow (2D projection along the plane normal) for a variety of normal direction vectors, and selecting a plane with the maximum shadow area normal, then locating it at the height along the input shape with maximum surface area, and/or (3) place the parting plane on the center of gravity for the input shape, and select the orientation to maximize the cross-sectional area of the shape on the plane. Other implementations are also possible.

Optimization approaches can use a classical optimization algorithm to locate the parting plane while minimizing the total volume of material added to the part when the moldability constraint is applied (i.e., by running the moldability constraint and computing the volume change for the objective function of the optimization algorithm). Note that this optimization step can be run prior to (and is separate from) the shape synthesis process which evolves the shape subsequently.

In a shape synthesis context (such as generative design or automated modeling), the location and orientation of the parting plane can be added as design variables alongside the shape optimization process itself. An initial guess for the parting plane location is provided, either as a user-supplied quantity or by some other means (such as those described above). Then, as the optimization progresses, the initial guess is refined so as to minimize the shape and/or topology optimization objective function and satisfy the constraints.

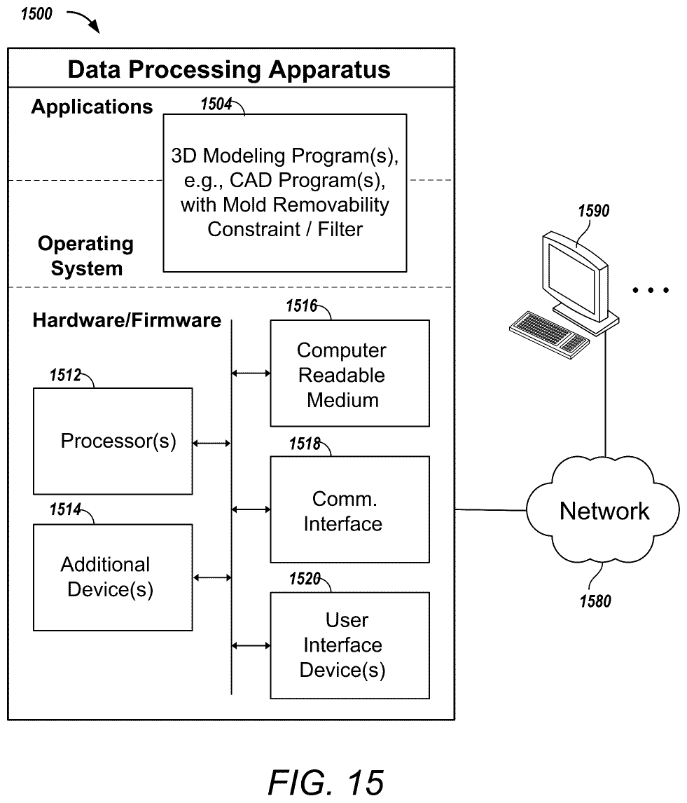

FIG. 15 is a schematic diagram of a data processing system including a data processing apparatus 1500, which can be programmed as a client or as a server. The data processing apparatus 1500 is connected with one or more computers 1590 through a network 1580. While only one computer is shown in FIG. 15 as the data processing apparatus 1500, multiple computers can be used. The data processing apparatus 1500 includes various software modules, which can be distributed between an applications layer and an operating system. These can include executable and/or interpretable software programs or libraries, including tools and services of one or more 3D modeling programs 1504 that implement the draft angle sculpting and analysis processes described. Thus, the 3D modeling program(s) 1504 can be CAD program(s) 1504 (such as CAD program(s) 116) and can implement one or more shape synthesis processes (e.g., using level-set based method(s) for generative design) for shape and/or topology optimization and physical simulation operations (finite element analysis (FEA) or other) that incorporate the use of a mold removability constraint/filter.

In some implementations, the shape synthesis processes can use a density-based approach, such as the SIMP method, to represent the three-dimensional shape of the modeled object during shape synthesis. In such implementations, the update rule is modified to account for the facts that (1) intermediate densities have intrinsic meaning to SIMP in a way different than positive-but-near-zero level set values, and (2) early in the optimization process with SIMP, large regions of intermediate density material are present, and when a clear solid-void boundary is not visible it is difficult to discern how and where to apply material change that effectively adds draft.

To address these issues, the update still takes the form of the sum of a value derived from the cells above the current cell and a constant (see Equation 1 above), but min is replaced with max (both effectively ensure the shape is growing), and the level set field ϕ is replaced with the density field D.

$${D}_{x} ← max ( {D}_{x} , D ( {x}^{′} ) + c ) \qquad ( 6 )$$

Note that depending on the ejection direction, interpolation between multiple cells may be needed to obtain the neighbor cell density value (D(x′)) in Equation 6. With c=0, and applying the rule with the same single-pass algorithm described above, overhang removal is thus achieved with a density-based approach to shape modeling and modification.

In addition, applying a uniform constant c can introduce unwanted regions of intermediate density away from the current shape, and so c can be adjusted depending on the neighborhood of the current voxel. Recall that SIMP postprocessing typically utilizes a thresholding approach to distinguish between solid and void regions and obtain a manufacturable structure. In this thresholding approach, a threshold value is selected (manually or automatically), and voxels above the threshold are treated as solid, while those below are treated as void in the final design. This solid-void transition threshold or an approximation thereof (the “threshold”) can then be used as described below. Note that it may be sufficient to select 0.5 (half density) as the threshold for the purposes of this algorithm if the postprocessing threshold is dynamically determined or otherwise not available during optimization.

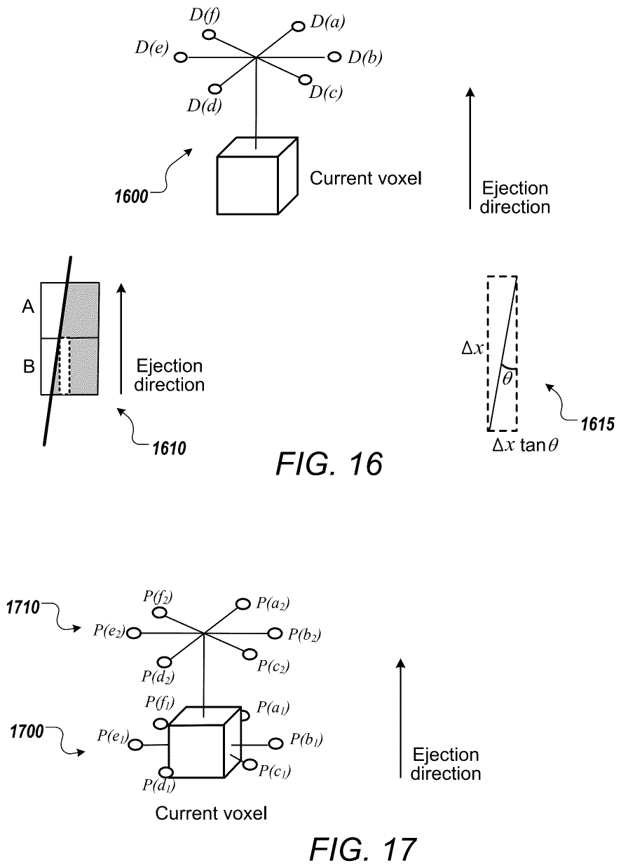

FIG. 16 shows neighbor sampling and a density field update rule used to implement the mold removability filter. Conceptually, the density field is sampled in several places above the current voxel, and the update rule looks for density values above the threshold. If values above the threshold are found, this cell is near the border or interior of the shape, and a fixed positive c should be used during the update. If density values are all less than the threshold then the update should be applied, but with c=0. This avoids overhang formation during the early stages of SIMP when intermediate density regions are more prevalent.

Thus, referring to schematic 1600, voxels in a ring perpendicular to the ejection direction some distance above the current voxel (D(a), D(b), D(c), D(d), D(e), D(f)) can be sampled. The number of points to sample should be at least four, but can vary with the implementation. Further, the amount of the distance above the current voxel (i.e., how far to travel up along the ejection direction and out to the points to be sampled) can be determined through experimentation in order to reliably create the desired draft angle in the final model.

If any one of the samples is greater than the solid-void threshold value (or its approximate), this voxel is “close” to the shape boundary and should be updated with a positive c. The value of c to use can depend on the mesh topology, and should be selected so that the change in density created matches the change in density of a series of cells representing a wall at the draft angle. For a voxel grid and a vertical ejection direction, the value c can be approximated using the change in volume of the filled portion of the cell. For example, in schematic 1610, voxel B has more interior volume than voxel A by an amount visualized by box 1615. The volume of this box 1615 is Δx³ tan θ (recall that θ is the draft angle), and the increase in density of voxel B is c=tan θ. Thus, the SIMP update rule can be implemented as:

$${D}_{x} ← max ( {D}_{x} , D ( {x}^{′} ) + c ) \qquad ( 7 )$$

$$c = tan θ if D ( i ) > t for some i ∈ ( a , f )$$

$$c = 0 otherwise .$$

Note that while this approximation assumes the orientation of the ejection direction and of the drafted face, it should be a reasonable guess in other configurations. A similar calculation can be performed for non-voxel meshes.

If a solid-void transition is not available or using it is not desirable, other metrics can be used to decide when to apply the draft update. For example, a larger neighborhood of points above the current voxel (i.e., with a larger radius in the ring from schematic 1600) can be sampled, and the draft update can be applied if a density value of nearly 1.0 is detected (i.e., select a threshold near 1.0 above which density values are determined to be “definitely interior”, and use proximity to such a value in the region above the current cell as a threshold for applying the draft update). The gradient of the density field in the region above the current cell can be assessed, and a threshold can be applied to the gradient magnitude to detect regions where the shape is transitioning from solid to void. Regions where this “above lateral gradient” magnitude is larger than the threshold should be updated using draft.

Because the SIMP method produces gray regions, especially early in the optimization process, it may be desirable to avoid applying draft early in the optimization to prevent situations where gray values near the threshold value but far from the actual border of the shape are incorrectly identified as needing draft applied using the method described above. In this case, the draft angle can be gradually ramped up from zero to the final value (e.g., a user-specified final value) over a number of iterations early in the solve. Note that a draft angle of zero still removes overhangs, which will ensure the early evolution of the shape remains generally manufacturable, if not fully drafted.

The single-pass approach described above applies equally well to density-based methods, such as SIMP, except that there is no need to Boolean intersect the parting surface distance field into the result; simply stopping the update at the parting surface is sufficient. Further, it may be desirable to add a small amount of blur to the transition between solid (above the parting surface) and void (below). In this case, something similar to the overshoot described above can be used, with a few tweaks to describe a density field. Equation 3 above can be adjusted for SIMP as follows to introduce a blurry region of fixed size near the parting surface:

$${D}_{x} ← max ( {D}_{x} , min ( D ( {x}^{′} ) + c , H ) ) \qquad ( 8 )$$

$$H = \pm clamp ( k ( h / Δ x - 0. 5 ) , 0 , 1 )$$

$$h = ( x - {p}_{0} ) \cdot \hat{d}$$

Note that a transition width k (in voxels) is introduced, over which the density transitions from solid to void near the parting surface, and Δx is the average width of a cell. The remainder of the second line in Equation 8 causes h to vary from 1.0 at k/2 voxels above the parting surface down to 0.0 (or a small value if ersatz material is being used) at k/2 voxels below the parting surface.

The bounding box issues addressed above (as well as the use of the mold removability algorithm(s) as a post-process on designs, as a pre-process for generating training data for an AI model, and/or as an analysis tool to aid in locating regions of a design which are not castable) are equally applicable to density-based methods, such as SIMP. For avoiding undercuts near the parting surface, a similar approach to that described above (for level set methods) can be used by extending the dense region downward past the parting surface. For example, for SIMP, the same update rule as Equation 8 can be used, with an adjustment to H such that the center of the blurred region is somewhat beyond the parting surface, and with c=0 when h≤0.

Moreover, for controlling draft of preserve bodies, the same options discussed above in connection with FIGS. 9A-9D are applicable to density-based method, such as SIMP. The result shown in FIG. 9B is achieved by processing the preserve bodies along with the organic/optimized geometry. To achieve the partial draft of FIG. 9C (in which overhangs are removed but vertical faces are not drafted) in a density-based implementation, a couple of options are available. First, the preserve bodies can be reduced to thin shells on the overhanging faces (as described in connection with FIG. 10), and the preserve bodies can be replaced with these thin shells when applying the draft update rule. To do this, in addition to removing the preserve bodies, Boolean difference and union operators for density fields can be used, which can be approximated with Dₓ←min(Dₓ, 1. −Oₓ) and Dₓ←max(Dₓ, Oₓ) for density field D and operator density field O, respectively. The actual process of deciding which voxels belong in the preserve skin regions will follow a similar process to that described above for level sets, with minor adjustments to work with density instead of level set values.

Second, the same effect can be achieved using an additional sampling of the neighborhood. Given a second density field which just represents the preserves (P), this second density field can be queried to determine if the current voxel is close to the preserve shape and use this to selectively turn off the draft portion of the update (but not undercut) in the neighborhood of the preserves. Specifically, the preserve density field can be sampled along a circle centered on the current cell and orthogonal to the ejection direction as shown at 1700 in FIG. 17, which shows sampling in a preserve density field to determine proximity to the preserve body. If any preserve density is found above a threshold (i.e., the solid-void threshold, or another threshold between 0 and 1), this voxel is laterally near a preserve and we set c=0.

To achieve the no-draft-of-preserves result of FIG. 9D in a density-based implementation, a similar approach to that described above can be used, in which the preserves are removed entirely using a density Boolean difference, followed by application of the update rule. The same effect can also be achieved using an additional sampling of the neighborhood. Using an approach similar to that described above, the preserve density field can be sampled along two circles, including one 1710 above (by an experimentally determined distance) and one 1700 adjacent to the current voxel, as shown in FIG. 16. If any preserve density above a threshold (i.e., the solid-void threshold, or another threshold between 0 and 1) is found, this voxel is “near a preserve” and the update rule is skipped entirely, which allows both undercuts and undrafted faces.

Returning to FIG. 15, the program(s) 1504 can potentially implement manufacturing control operations (e.g., generating and/or applying toolpath specifications to effect manufacturing of designed objects). The number of software modules used can vary from one implementation to another. Moreover, the software modules can be distributed on one or more data processing apparatus connected by one or more computer networks or other suitable communication networks.

The data processing apparatus 1500 also includes hardware or firmware devices including one or more processors 1512, one or more additional devices 1514, a computer readable medium 1516, a communication interface 1518, and one or more user interface devices 1520. Each processor 1512 is capable of processing instructions for execution within the data processing apparatus 1500. In some implementations, the processor 1512 is a single or multi-threaded processor. Each processor 1512 is capable of processing instructions stored on the computer readable medium 1516 or on a storage device such as one of the additional devices 1514. The data processing apparatus 1500 uses the communication interface 1518 to communicate with one or more computers 1590, for example, over the network 1580. Examples of user interface devices 1520 include a display, a camera, a speaker, a microphone, a tactile feedback device, a keyboard, a mouse, and VR and/or AR equipment. The data processing apparatus 1500 can store instructions that implement operations associated with the program(s) described above, for example, on the computer readable medium 1516 or one or more additional devices 1514, for example, one or more of a hard disk device, an optical disk device, a tape device, and a solid state memory device.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, special purpose microprocessors. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display) display device, an OLED (organic light emitting diode) display device, or another monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Thus, unless explicitly stated otherwise, or unless the knowledge of one of ordinary skill in the art clearly indicates otherwise, any of the features of the embodiments described above can be combined with any of the other features of the embodiments described above.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A method comprising:
obtaining, by a shape modeling computer program, a draft angle, an ejection direction, and a three-dimensional shape of a modelled object for which a corresponding physical structure can be manufactured using a casting or molding process, wherein the draft angle and the ejection direction are for the casting or molding process, and the three-dimensional shape of the modelled object is defined within a design domain by a data structure comprising discrete elements holding data values from which the three-dimensional shape of the modelled object is determinable;
modifying, by the shape modeling computer program, the data values in the discrete elements to add material to the modelled object, the modifying comprising, for each of the discrete elements, changing a current value of the discrete element based on a comparison of the current value with an other value and a constant value, the other value being determined from one or more values found in one or more other discrete elements in the data structure located away from the discrete element along the ejection direction, and the constant value being determined for the draft angle; and
providing, by the shape modeling computer program, the data structure with the modified data values, which have redefined the three-dimensional shape of the modelled object within the design domain, for further processing.

2. The method of claim 1, where the other value is determined at a point located a predefined distance away from the discrete element along the ejection direction.

3. The method of claim 2, comprising determining the other value at the point by interpolating data values found in two or more other discrete elements in the data structure that surround the point.

4. The method of claim 1, wherein the modifying comprises modifying the data values in order of their discrete elements' distance along the ejection direction from a surface.

5. The method of claim 4, wherein the surface comprise a parting surface, the modifying is performed for each side of the parting surface and extending thru the parting surface, and the changing is further based on a comparison of the other value plus the constant value with a further value, the further value being determined based on a distance between the parting surface and the discrete element.

6. The method of claim 5, wherein extending the modifying thru the parting surface comprises extending by an overshoot depth and adjusting the changing inside the overshoot depth.

7. The method of claim 1, wherein the data structure holds valid signed distance field values only in discrete elements falling within a predefined distance of a zero contour of a current version of the three-dimensional shape of the modelled object, and the method comprises extending the signed distance field outward based on the draft angle and a maximum distance from the parting surface of any domain element.

8. The method of claim 1, wherein obtaining the three-dimensional shape of the modelled object comprises creating the three-dimensional shape in a shape synthesis process, and the modifying is performed within an iterative loop of the shape synthesis process.

9. The method of claim 8, comprising excluding at least one portion of at least one preserve body from being operated on by the modifying.

10. The method of claim 1, comprising, before the modifying, adding to the discrete elements by an amount determined from the geometry of the draft being created and the shape of the design domain and parting surface to ensure drafted final shape can be fully represented in the data structure.

11. The method of claim 1, wherein the further processing is for use in manufacturing the physical structure using the casting or molding process.

12. The method of claim 1, comprising:
using the data structure with the modified data values to generate toolpath specifications for one or more computer-controlled manufacturing systems; and
manufacturing (i) at least a portion of a mold for the physical structure with the one or more computer-controlled manufacturing systems using the toolpath specifications, wherein the portion of the mold is a negative of a portion of the physical structure or (ii) at least a portion of a doppelganger of the physical structure with the one or more computer-controlled manufacturing systems using the toolpath specifications, wherein the at least a portion of the doppelganger of the physical structure is usable to form at least a portion of a mold for the physical structure.

13. A system comprising:
a non-transitory storage medium having instructions of a shape modeling computer program stored thereon; and
one or more data processing apparatus configured to run the instructions of the shape modeling computer program to cause the one or more data processing apparatus to perform operations comprising:
obtaining a draft angle, an ejection direction, and a three-dimensional shape of a modelled object for which a corresponding physical structure can be manufactured using a casting or molding process, wherein the draft angle and the ejection direction are for the casting or molding process, and the three-dimensional shape of the modelled object is defined within a design domain by a data structure comprising discrete elements holding data values from which the three-dimensional shape of the modelled object is determinable;
modifying the data values in the discrete elements to add material to the modelled object, the modifying comprising, for each of the discrete elements, changing a current value of the discrete element based on a comparison of the current value with an other value and a constant value, the other value being determined from one or more values found in one or more other discrete elements in the data structure located away from the discrete element along the ejection direction, and the constant value being determined for the draft angle; and
providing the data structure with the modified data values, which have redefined the three-dimensional shape of the modelled object within the design domain, for further processing.

14. The system of claim 13, where the other value is determined at a point located a predefined distance away from the discrete element along the ejection direction.

15. The system of claim 14, wherein the operations comprise determining the other value at the point by interpolating data values found in two or more other discrete elements in the data structure that surround the point.

16. The system of claim 13, wherein the modifying comprises modifying the data values in order of their discrete elements' distance along the ejection direction from a surface.

17. The system of claim 16, wherein the surface comprise a parting surface, the modifying is performed for each side of the parting surface and extending thru the parting surface, and the changing is further based on a comparison of the other value plus the constant value with a further value, the further value being determined based on a distance between the parting surface and the discrete element.

18. The system of claim 17, wherein extending the modifying thru the parting surface comprises extending by an overshoot depth and adjusting the changing inside the overshoot depth.

19. The system of claim 13, wherein the data structure holds valid signed distance field values only in discrete elements falling within a predefined distance of a zero contour of a current version of the three-dimensional shape of the modelled object, and the operations comprise extending the signed distance field outward based on the draft angle and a maximum distance from the parting surface of any domain element.

20. The system of claim 13, wherein obtaining the three-dimensional shape of the modelled object comprises creating the three-dimensional shape in a shape synthesis process, and the modifying is performed within an iterative loop of the shape synthesis process.

21. The system of claim 20, wherein the operations comprise excluding at least one portion of at least one preserve body from being operated on by the modifying.

22. The system of claim 13, wherein the operations comprise, before the modifying, adding to the discrete elements by an amount determined from the geometry of the draft being created and the shape of the design domain and parting surface to ensure drafted final shape can be fully represented in the data structure.

23. The system of claim 13, wherein the further processing is for use in manufacturing the physical structure using the casting or molding process.

24. The system of claim 13, comprising one or more computer-controlled manufacturing systems, wherein the operations comprises:
using the data structure with the modified data values to generate toolpath specifications for the one or more computer-controlled manufacturing systems; and
manufacturing (i) at least a portion of a mold for the physical structure with the one or more computer-controlled manufacturing systems using the toolpath specifications, wherein the portion of the mold is a negative of a portion of the physical structure or (ii) at least a portion of a doppelganger of the physical structure with the one or more computer-controlled manufacturing systems using the toolpath specifications, wherein the at least a portion of the doppelganger of the physical structure is usable to form at least a portion of a mold for the physical structure.

25. A non-transitory computer-readable medium tangibly encoding a computer program operable to cause data processing apparatus to perform operations comprising:
obtaining a draft angle, an ejection direction, and a three-dimensional shape of a modelled object for which a corresponding physical structure can be manufactured using a casting or molding process, wherein the draft angle and the ejection direction are for the casting or molding process, and the three-dimensional shape of the modelled object is defined within a design domain by a data structure comprising discrete elements holding data values from which the three-dimensional shape of the modelled object is determinable;
modifying the data values in the discrete elements to add material to the modelled object, the modifying comprising, for each of the discrete elements, changing a current value of the discrete element based on a comparison of the current value with an other value and a constant value, the other value being determined from one or more values found in one or more other discrete elements in the data structure located away from the discrete element along the ejection direction, and the constant value being determined for the draft angle; and
providing the data structure with the modified data values, which have redefined the three-dimensional shape of the modelled object within the design domain, for further processing.

26. The non-transitory computer-readable medium of claim 25, where the other value is determined at a point located a predefined distance away from the discrete element along the ejection direction.

27. The non-transitory computer-readable medium of claim 26, wherein the operations comprise determining the other value at the point by interpolating data values found in two or more other discrete elements in the data structure that surround the point.

28. The non-transitory computer-readable medium of claim 25, wherein the modifying comprises modifying the data values in order of their discrete elements' distance along the ejection direction from a surface.

29. The non-transitory computer-readable medium of claim 28, wherein the surface comprise a parting surface, the modifying is performed for each side of the parting surface and extending thru the parting surface, and the changing is further based on a comparison of the other value plus the constant value with a further value, the further value being determined based on a distance between the parting surface and the discrete element.

30. The non-transitory computer-readable medium of claim 29, wherein extending the modifying thru the parting surface comprises extending by an overshoot depth and adjusting the changing inside the overshoot depth.

31. The non-transitory computer-readable medium of claim 25, wherein the data structure holds valid signed distance field values only in discrete elements falling within a predefined distance of a zero contour of a current version of the three-dimensional shape of the modelled object, and the operations comprise extending the signed distance field outward based on the draft angle and a maximum distance from the parting surface of any domain element.

32. The non-transitory computer-readable medium of claim 25, wherein obtaining the three-dimensional shape of the modelled object comprises creating the three-dimensional shape in a shape synthesis process, and the modifying is performed within an iterative loop of the shape synthesis process.

33. The non-transitory computer-readable medium of claim 32, wherein the operations comprise excluding at least one portion of at least one preserve body from being operated on by the modifying.

34. The non-transitory computer-readable medium of claim 25, wherein the operations comprise, before the modifying, adding to the discrete elements by an amount determined from the geometry of the draft being created and the shape of the design domain and parting surface to ensure drafted final shape can be fully represented in the data structure.

35. The non-transitory computer-readable medium of claim 25, wherein the further processing is for use in manufacturing the physical structure using the casting or molding process.

36. The non-transitory computer-readable medium of claim 25, wherein the operations comprise:
using the data structure with the modified data values to generate toolpath specifications for one or more computer-controlled manufacturing systems; and
manufacturing (i) at least a portion of a mold for the physical structure with the one or more computer-controlled manufacturing systems using the toolpath specifications, wherein the portion of the mold is a negative of a portion of the physical structure or (ii) at least a portion of a doppelganger of the physical structure with the one or more computer-controlled manufacturing systems using the toolpath specifications, wherein the at least a portion of the doppelganger of the physical structure is usable to form at least a portion of a mold for the physical structure.
